(19) United States
(12) Patent Application Publication
(10) Pub. No.: US 2016/0208931 A1
(43) Pub. Date: Jul. 21, 2016

(54) RETAINING DEVICE FOR SEALING GASKET IN PRESSURE REGULATING VALVE

(71) Applicant: FISHER JEON GAS EQUIPMENT (CHENGDU) CO., LTD., Chengdu (CN)

(72) Inventors: Xiong Yikun, Chengdu (CN); Xiao Xiao, Chengdu (CN); Shi Yanbo, Chengdu (CN); Lei Yanwei, Chengdu (CN); Huo Yuxiong, Chengdu (CN)

(21) Appl. No.: 14/978,263

(22) Filed: Dec. 22, 2015

(30) Foreign Application Priority Data
Dec. 22, 2014 (CN) 201420869583.7
Jul. 6, 2015 (IN) 2579/MUM/2015

(51) Int. Cl. F16K 1/46

(52) U.S. Cl. CPC F16K 1/46

(57) ABSTRACT

Disclosed is a valve disk for a pressure regulating valve having a retaining device to keep a sealing gasket from becoming displaced. The retaining device of the valve disk increases the friction between the sealing gasket and a sealing gasket groove of the valve disk or secures the sealing gasket in place using an annular sleeve around a valve stem, thereby preventing the sealing gasket on the valve disk from tearing out and falling off when the pressure regulating valve is experiencing a high differential pressure or a high current velocity. Accordingly, the retaining device maintains the sealing of the pressure regulating valve, thereby increasing the work life of the pressure regulating valve.

### TECHNICAL FIELD

The present disclosure relates to a pressure regulating valve in a fluid control system, and in particular relates to the securement of a sealing gasket on a valve disk in a pressure regulating valve by a retaining device.

### BACKGROUND

Pressure regulating valves are used in fluid control systems to maintain a specific pressure of fluid within a fluid control system. To achieve this end, pressure regulating valves control the flow rate of a fluid through the valve. The ability of a pressure regulating valve to control fluid flow rate is often dependent upon the ability of the valve to seal properly. Thus, valves with high sealing performance are preferred.

In a typical pressure regulating valve, a valve disk is moved relative to a valve port by a valve stem (i.e., valve rod) in order to adjust fluid flow rate through the valve port in a very stable fashion. In some cases, a small spring in the valve disk assists with movement of the valve disk. A sealing gasket is provided on the valve disk and a complementary valve seat (i.e., valve port edge) is provided on the valve port. The sealing gasket and the complementary valve seat together form a tight seal when the valve disk closes the valve port.

Because the pressure difference across the valve port can be great, the sealing gasket on the valve disk is prone to be torn or blown off Although the pressure regulating valve can still work without a sealing gasket, the closing performance of the valve is diminished. Further, when the sealing gasket is torn off, it travels downstream with the flow of fluid, where it can have a harmful effect on the flow of fluid through the fluid control system. Additional solutions to the problem of a sealing gasket being torn off are desired.

### SUMMARY

In order to solve the problem mentioned above, the current disclosure provides a variety of embodiments of a valve disk for a pressure regulating valve. In the embodiments discussed below, a sealing gasket groove is arranged on the valve disk, and a sealing gasket is arranged in the sealing gasket groove. A retaining device is arranged on or in the valve disk in contact with the sealing gasket, and the displacement of the sealing gasket is restricted by the retaining device.

The retaining device may include one or a plurality of concave and/or convex portions of the sealing gasket groove of the valve disk, which may extend circumferentially or in a spiral, threaded configuration around the sealing gasket groove of the valve disk. The retaining device may include a portion of the sealing gasket groove of the valve disk having a rectangular, triangular, trapezoidal, or arc-shaped cross section. The retaining device may include an annular sleeve extending above the upper surface of the valve disk and over the sealing gasket groove. The valve disk may be connected to the valve stem. The retaining device may be pressed on to the valve disk by a step in the valve stem, wherein the step is formed by a decrease of the diameter of the valve stem. The retaining device may be connected to the valve stem through a first connecting hole disposed in the retaining device and may be connected to the valve disk by a second connecting hole disposed in the valve disk. The retaining device may have a concave or convex shape complementary to that of the sealing gasket. The valve disk and the retaining device may have a threaded connection or may be connected by one or more rivets.

The retaining device may increase the friction between the valve disk and the sealing gasket, thereby preventing the sealing gasket from falling off during times that the valve is experiencing a high pressure difference and high flow rate. Thus, the retaining device maintains the closing performance and increases the work life of the pressure regulating valve. The inclusion of a retaining device in a pressure regulating valve requires only a simple change of the structure of a valve disk and is economical because other parts do not have to be changed.

### BRIEF DESCRIPTION OF THE ACCOMPANYING DRAWINGS

Drawings, provided for further understanding of the present utility model and forming a part of the specification, are used to explain the present utility model together with embodiments of the present utility model rather than to limit the present utility model.

FIG. 1 illustrates an exemplary pressure regulating valve and a partial enlarged cross-sectional view of the pressure regulating valve in the prior art;

FIG. 2 illustrates a cross-sectional view of a valve disk and a sealing gasket thereof in the prior art;

FIG. 3 illustrates a partial cross-sectional view and an enlarged cross-sectional view of a valve disk and retaining device according to an embodiment of the present disclosure wherein the retaining device is a retaining groove with a rectangular cross-section in the inner side of the sealing gasket groove;

FIG. 4 illustrates a partial cross-sectional view of a valve disk and retaining device according to an embodiment of the present disclosure wherein the retaining device is a plurality of retaining grooves with rectangular cross-sections in the inner side of the sealing gasket groove;

FIG. 5 is a partial cross-sectional view of valve disk and retaining device according to an embodiment of the present disclosure wherein the retaining device is a retaining groove with a triangular cross-sections arranged in a spiral pattern in the inner side of the sealing gasket groove;

FIG. 6 is a partial cross-sectional view of valve disk and retaining device according to an embodiment of the present disclosure wherein the retaining device is a convex retaining strip with a trapezoidal cross-section in the inner side of the sealing gasket groove;

FIG. 7 is a partial cross-sectional view of valve disk and retaining device according to an embodiment of the present disclosure wherein the retaining device is a plurality of convex retaining strips with trapezoidal cross-sections in the inner side of the sealing gasket groove;

FIG. 8 is a partial cross-sectional view of a valve disk, retaining device, and valve stem according to an embodiment of the present disclosure wherein the retaining device includes an annular sleeve surrounding the valve stem; and

FIG. 9 is a partial cross-sectional view of a valve disk, retaining device, and valve stem according to an embodiment of the present disclosure wherein the retaining device includes an annular sleeve surrounding the valve stem and a U-shaped body.

### DETAILED DESCRIPTION OF EMBODIMENTS

The preferred embodiments are described in conjunction with the drawings as follows. It shall be understood that the preferred embodiments described herein are only used to describe and explain the present disclosure and shall not be construed as improper limitations on the same. The embodiments of the present disclosure and the features of the embodiments can be combined with each other if there is no conflict.

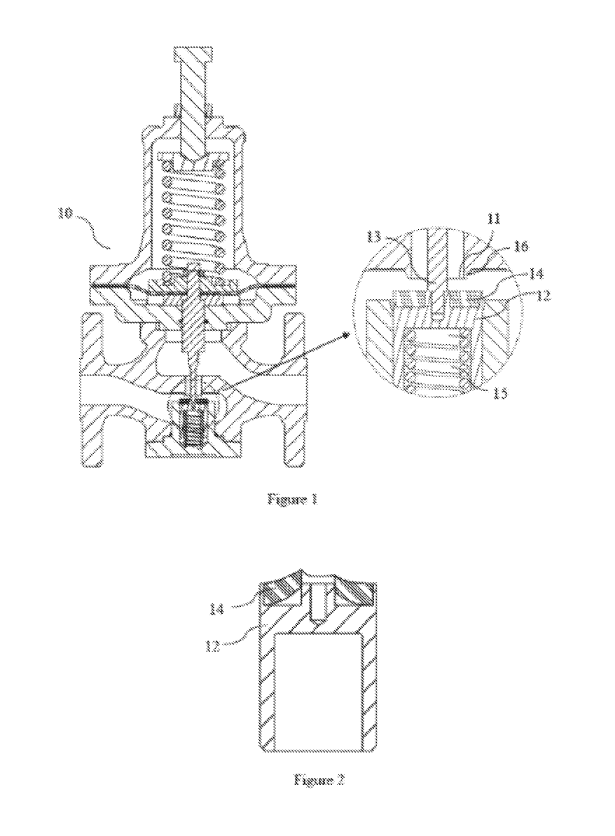

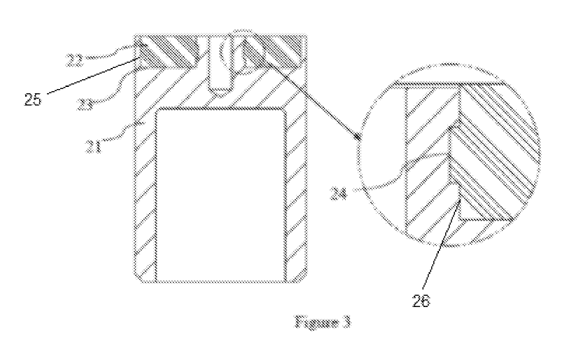

FIG. 1 illustrates a pressure regulating valve 10 of the prior art. The enlarged view of FIG. 1 shows a valve disk 12 connected to a valve stem 13. The disk valve 12 is moved by the valve stem 13 relative to a valve port 11 of the pressure regulating valve 10 to restrict or block the flow of a fluid through the valve port 11. A sealing gasket 14 is arranged on the valve disk 12 to seal the valve port 11 by being pressed against a valve seat 16. A small spring 15 may assist with the closing of the valve port 11. As discussed above, the valve port sealing gasket 14 in embodiments in the prior art are prone to be blown off or partially torn off as a result of extreme pressure differences across the valve port 11 and high fluid flow rates through the valve port 11. FIG. 2 illustrates the disk valve 12 and sealing gasket 14 of FIG. 1 after a portion of the sealing gasket 14 has been torn away.

FIG. 3 illustrates an embodiment of the present disclosure. In FIG. 3, the valve disk 21 has a sealing gasket groove 23, and the sealing gasket groove 23 accommodates a sealing gasket 22 that cooperates with a valve port (not pictured) to seal a valve. An annular retaining groove 24 is arranged in the sealing gasket groove 23. If the sealing gasket 22 is fit into the sealing gasket groove 23 by vulcanization, the sealing gasket 22 fills the retaining groove 24 automatically and fits closely with the retaining groove 24 after solidifying. The sealing gasket 22 may alternately be fit into the sealing gasket groove 23 by riveting. The retaining groove 24 increases the friction between the valve disk 21 and the sealing gasket 22 to keep the sealing gasket 22 from being torn out of the sealing gasket groove 23.

In FIG. 3, the cross-section of the retaining groove 24 is rectangular. In other embodiments within the scope of the present disclosure, the retaining groove 24 may be arc-shaped, trapezoidal, triangular, or have another shape. In FIG. 3, only one retaining groove 24 is provided. In other embodiments within the scope of the present disclosure, a plurality of retaining grooves may be provided. In FIG. 3, the retaining groove 24 is depicted on an inner side 26 of the sealing gasket groove 23. In other embodiments within the scope of the present disclosure, the retaining groove 24 may be placed on the outer side 25 of the sealing gasket groove 23 or one or more retaining grooves 24 may be placed on both the inner side 26 and outer side 25 of the sealing gasket groove 23.

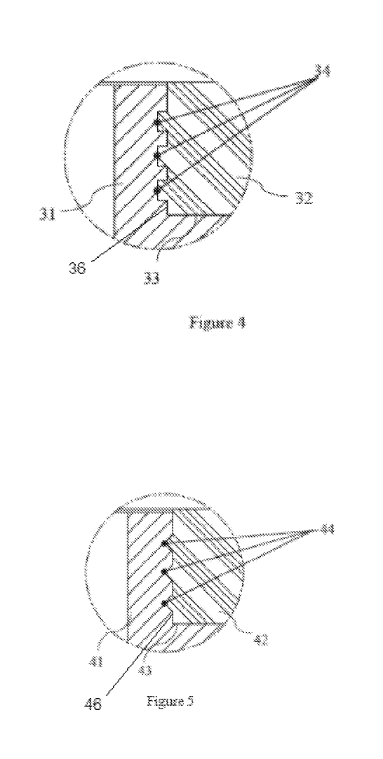

In FIG. 4, a sealing gasket groove 33 is arranged on a valve disk 31, and the sealing gasket groove 33 is used for accommodating a sealing gasket 32. In FIG. 4, the retaining device is a plurality of annular retaining grooves 34 placed on the inner side 36 of the sealing gasket groove 33. Although three retaining grooves 34 are depicted in FIG. 4, the retaining device may include a different number of retaining grooves 34, such as two retaining grooves 34 or four retaining grooves 34.

In FIG. 5, a sealing gasket groove 43 is arranged on a valve disk 41, and the sealing gasket groove 41 is used for accommodating a sealing gasket 42. In FIG. 5, the retaining device is a retaining groove 44 having a triangular cross-section placed on the inner side 46 of the sealing gasket groove 43. The number and shape of the retaining grooves 44 may differ in various embodiments within the scope of the present disclosure. In the embodiment depicted in FIG. 5, the sealing gasket 42 may be inserted into the sealing gasket groove 43 by spinning it because the retaining groove 44 is arranged in a spiral, threaded pattern.

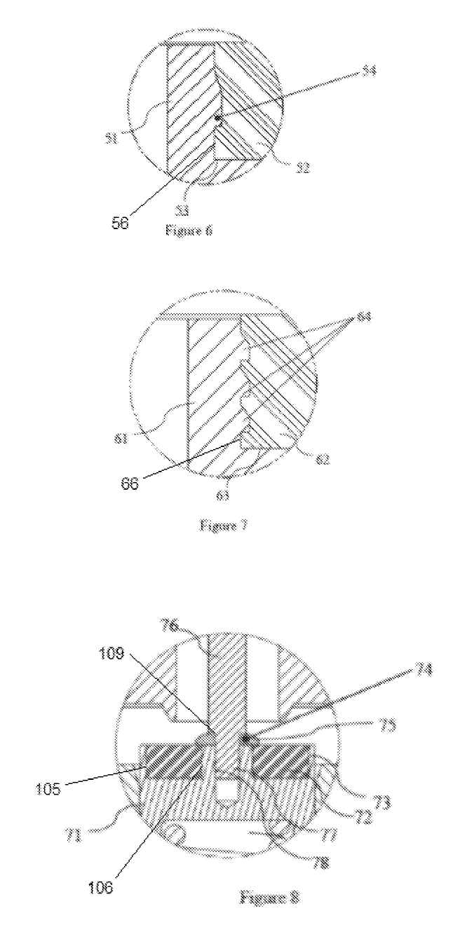

In FIGS. 3-5, the retaining device includes concave retaining grooves 24, 34, and 44. In contrast, FIGS. 6 and 7 depict embodiments within the scope of the present disclosure having retaining devices that include convex retaining strips. FIG. 6 illustrates a partial cross-sectional side view of a convex retaining strip 54 in sealing gasket groove 53 of valve disk 51, which accommodates sealing gasket 52. The retaining strip 54 is arranged on the inner side 56 of the sealing gasket groove 53. In other embodiments within the scope of the present disclosure, the retaining strip 54 may be arranged on the outer side (not pictured) of the groove 53 or both walls of the groove 53 may have retaining strips 54.

FIG. 7 depicts an alternate embodiment within the scope of the present disclosure in a plurality of retaining strips 64 are arranged on the sealing gasket groove 63 of the valve disk 61. FIG. 7 shows an embodiment having three retaining strips 64, but other embodiments within the scope of the present disclosure may have more or less. In the embodiment depicted in FIG. 7, the cross-section of the retaining strips 64 arranged on the sealing groove 63 of the valve disk 61 is trapezoidal. In other embodiments within the scope of the present disclosure, the cross-section of the retaining strips 64 arranged on the sealing gasket groove 63 of the valve disk 61 may be rectangular, triangle, arc-shaped, etc. The retaining strips 64 in the embodiment depicted in FIG. 7 can be arranged on the inner side 66 of the sealing gasket groove 63 on the valve disk 61. It should be understood that the retaining strips 64 also can be arranged on the outer side (not pictured) of the sealing gasket groove 63 on the valve disk 61, or can be arranged on both the inner side 66 and outer side.

In some embodiments within the scope of the present disclosure, the retaining device may include both a retaining groove and a retaining strip arranged on the groove of the valve disk in this embodiment. The groove of the valve disk is annular so the groove has an inner side wall and an outer side wall. One or more retaining groove and one or more retaining strip can be arranged on the inner side wall and the outer side wall to further increase the friction between the sealing gasket and the groove and prevent the sealing gasket from falling off.

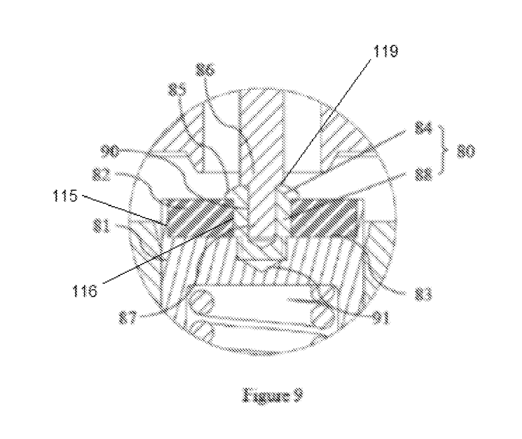

FIG. 8 depicts a retaining device that is an annular sleeve 74 that is placed on the valve disk 71 and surrounds the valve stem 76. The valve disk 71 is connected with the valve stem 76 and includes a sealing gasket groove 73 to accommodate sealing gasket 72. In an assembled state, the annular sleeve 74 tightly presses against the valve disc 71, and an outer edge 75 of the valve disk 71 covers the sealing gasket 72, which is arranged in the sealing gasket groove 73 of the valve disk 71, to prevent the sealing gasket 72 from falling out of the sealing gasket groove 73 of the valve disk 71. The valve stem 76 connects to the valve disk 71 at an end portion 77 that has a reduced diameter that is inserted into a connecting hole 78 of the valve disk 71 and fixed to the valve disk 71. In some embodiments within the scope of the present disclosure, the end portion 77 may be connected to the connecting hole 78 by a threaded connection. In other embodiments within the scope of the present disclosure, the end portion 77 may be connected to the connecting hole 78 by rivets, a muff-connection, or another connecting means. Because the diameter of the end 77 of the valve stem 76 decreases, an annular step 109 is formed at the position of the decrease. An outer edge portion 75 of the annular sleeve 74 is tightly pressed against the sealing gasket 72 by the annular step 109 of the valve stem 76 and thus secures the sealing gasket 72 in place.

In other embodiments within the scope of the present disclosure, a retaining device may include not only the annular sleeve 74 discussed with respect to FIG. 8 but may also include a retaining groove or retaining strip in the outer side 105 or inner side 106 of the sealing gasket groove 73. In such embodiments, the annular sleeve 74 secures the sealing gasket 72 in place, and the retaining groove or/and the retaining strip further increases the friction between the sealing gasket 72 and the outer side 105 or inner side 106 of the sealing gasket groove 73, preventing the sealing gasket 72 from falling off.

FIG. 9 shows a valve disk 81 comprising a retaining device 80. The retaining device 80 in this embodiment comprises an annular sleeve 84 and a body 88 which is integrally formed with the annular sleeve 84. The body 88 has a cross section that is U-shaped. The U-shaped body 88 is arranged below the annular sleeve 84, and has a first connecting hole 90. An end portion 87 of the valve stem 86 connects to the first connecting hole 90. The valve disk 81 has a sealing gasket groove 83, and the valve disk 81 is provided with a second connecting hole 91 which is used for connecting to the retaining device 80. The end portion 87 of the valve stem 86 connects to the retaining device 80 through the first linking hole 90. The retaining device 80 is fixed to the second connecting hole 91 of the valve disk 81. By this kind of connection, the valve stem 86 and the valve disk 81 can be fixed connected via the retaining device 80. If the valve port needs to be opened, the valve disk 81 moves downward with the valve stem 86. As in FIG. 8, when the sealing gasket 83 and the valve disk 81 are in the assembled status, an annular step 119 presses down on the annular sleeve 84, and the outer edge part 85 of the annular sleeve 84 of the retaining device 80 tightly presses onto the sealing gasket 82, which prevents the sealing gasket 82 from falling off.

In FIG. 9, the retaining device 80 and the second connecting hole 91 are threadably connected. In other embodiments within the scope of the present disclosure, the retaining device 80 and the valve disc 81 can be connected in other connecting ways, such as muff-connection or rivet connection, etc. The annular sleeve 84 and the U-shaped body 88 of the retaining device 80 are formed integrally in FIG. 9, but the retaining device 80 and the U-shaped body 88 may not be integrally formed in other embodiments within the scope of the present disclosure.

Optionally, the outer surface 116 of the U-shaped body 88 of the retaining device 80 or the outer surface 115 of the sealing gasket groove 83 can be provided with a retaining groove or a retaining strip, or both a retaining groove or a retaining strip to further assist in keeping the sealing gasket 82 from falling off.

What is claimed is:

1. A valve disc for a pressure regulating valve comprising:
a sealing gasket groove in the valve disk, the sealing gasket groove having inner and outer sides;
a sealing gasket secured in the sealing gasket groove by a retaining device, wherein the retaining device includes at least one of:
a convex retaining groove arranged on either the inner or outer side of the annular groove;
a concave retaining strip arranged on either the inner or outer side of the annular groove.

2. The valve disc of claim 1, wherein the valve disc includes a plurality of convex retaining grooves.

3. The valve disc of claim 1, wherein a cross-section of the retaining groove is one of arc-shaped, trapezoidal, rectangular, and triangular.

4. The valve disc of claim 1, wherein the valve disc includes a plurality of concave retaining strips.

5. The valve disc of claim 1, wherein the concave retaining strip is arranged in a spiral pattern.

6. The valve disc of claim 1, wherein the concave retaining strip is one of rectangular, trapezoidal, triangular, and arc-shaped.

7. The valve disc of claim 1, wherein the retaining device includes at least one convex retaining groove and at least one concave retaining strip.

8. The valve disc of claim 1, wherein the sealing gasket is vulcanized and fits closely with the at least one of a convex retaining groove and a convex retaining strip.

9. A valve disc for a pressure regulating valve comprising:
a sealing gasket groove in an upper surface of the valve disk, the sealing gasket groove having inner and outer sides;
a sealing gasket secured in the sealing gasket groove by a retaining device, wherein the retaining device includes an annular sleeve that surrounds a valve stem;
an annular step of the valve stem formed where the valve stem decreases in diameter to form an end portion of the valve stem;
a connecting hole in the valve disk, wherein the end portion of the valve stem is inserted into and connected to the valve disk;
wherein an outer edge portion of the annular sleeve is pressed against the sealing gasket by the annular step.

10. The valve disc of claim 9, wherein the end portion of the valve stem is connected to the valve disk by a threaded connection.

11. The valve disc of claim 9, wherein the end portion of the valve stem is connected to the valve disk by at least one of rivets and a muff-connection.

12. The valve disc of claim 11, further including at least one of:
a convex retaining groove arranged on either the inner or outer side of the annular groove;
a concave retaining strip arranged on either the inner or outer side of the annular groove.

13. A valve disc for a pressure regulating valve comprising:
a sealing gasket groove in an upper surface of the valve disk, the sealing gasket groove having inner and outer sides;
a sealing gasket secured in the annular groove by a retaining device, wherein the retaining device includes an annular sleeve that surrounds a valve stem and a body having a first connecting hole arranged below the annular sleeve;
an annular step of the valve stem formed where the valve stem decreases in diameter to form an end portion of the valve stem, wherein an end portion of the valve stem is inserted into the first connecting hole and connected to the body of the receiving device;
a second connecting hole in the valve disk, wherein the body of the receiving device is inserted into and connected to the valve disk;
wherein an outer edge portion of the annular sleeve is pressed against the sealing gasket by the annular step.

14. The valve disc of claim 13, where in the retaining device further includes at least one of a convex retaining groove and a concave retaining strip.

15. The valve disc of claim 14, wherein the at least one of a convex retaining groove and a concave retaining strip is arranged on the outer side of the annular groove or an outer side of the body.

16. The valve disc of claim 13, wherein the annular sleeve and body of the retaining device are formed integrally.

17. The valve disc of claim 13, wherein the annular sleeve and body of the retaining device are separate but connected.

18. The valve disc of claim 13, wherein the retaining device and the second connecting hole are threadably connected.

19. The valve disc of claim 13, wherein the retaining device and the second connecting hole are connected by rivets or a muff-connection.

20. The valve disc of claim 13, wherein the body is U-shaped.
